(19) United States
(12) Patent Application Publication
(10) Pub. No.: US 2013/0342784 A1
(43) Pub. Date: Dec. 26, 2013

(54) LIQUID CRYSTAL DISPLAY DEVICE

(71) Applicant: Japan Display Inc., Tokyo (JP)

(72) Inventor: Saburo WATANABE, Chosei (JP)

(21) Appl. No.: 13/920,328

(22) Filed: Jun. 18, 2013

(30) Foreign Application Priority Data
Jun. 22, 2012 (JP) 2012-141401

(51) Int. Cl. G02F 1/1333

(52) U.S. Cl. CPC G02F 1/133308
USPC 349/58

(57) ABSTRACT

The backlight includes a surface-mount type light emitting component that emits light in an upper surface direction, a wiring board on which the light emitting component is mounted, and a light guide plate overlapping with the liquid crystal display panel. The frame integrally includes a first portion that supports the light guide plate, a second portion facing an edge surface of the light guide plate with a gap, and a third portion that supports the liquid crystal display panel. The wiring board is attached to the second portion such that the light from the light emitting component is incident on the edge surface of the light guide plate. The metal block is fixed to the housing and a surface of the second portion of the frame, the surface being on the side opposite to a surface on which the wiring board is attached.

### CROSS-REFERENCE TO RELATED APPLICATION

The present application claims priority from Japanese application JP2012-141401 filed on Jun. 22, 2012, the content of which is hereby incorporated by reference into this application.

### BACKGROUND OF THE INVENTION

1. Field of the Invention

The present invention relates to a liquid crystal display device.

2. Description of the Related Art

In a display device including a sidelight type backlight, light incident on the edge surface of a light guide plate propagates through the interior of the light guide plate and exits from the surface thereof (JP 2007-42552 A). As a light source of a backlight, a light emitting diode (LED) is generally used. The light source is mounted on a wiring board and arranged so as to face the edge surface of the light guide plate.

Recently, the number of light sources of a backlight is increased with the demand of a high-luminance liquid crystal display device, so that it is necessary to enhance a heat dissipation property. Especially in a structure in which the wiring board having the light source mounted thereon is attached to a frame, heat conducted from the light source to the frame is not allowed to escape, and therefore, countermeasures have to be taken.

### SUMMARY OF THE INVENTION

It is an object of the invention to enhance a heat dissipation property of a backlight.

(1) A liquid crystal display device according to an aspect of the invention includes: a liquid crystal display panel; a sidelight type backlight used as a surface light source of the liquid crystal display panel; a frame that supports the liquid crystal display panel and the backlight; a housing; and a metal block present between the frame and the housing; wherein the backlight includes a surface-mount type light emitting component that emits light in an upper surface direction, a wiring board on which the light emitting component is mounted, and a light guide plate arranged so as to overlap with the liquid crystal display panel, the frame integrally includes a first portion that supports the light guide plate, a second portion facing an edge surface of the light guide plate with a gap, and a third portion that supports the liquid crystal display panel, the wiring board is attached to the second portion such that the light from the light emitting component is incident on the edge surface of the light guide plate, and the metal block is fixed to the housing and a surface of the second portion of the frame, the surface being on the side opposite to a surface on which the wiring board is attached. According to the aspect of the invention, since the metal block allows heat conducted from the light emitting component to the wiring board to escape from the frame to the housing, a heat dissipation property of the backlight can be enhanced.

(2) In the liquid crystal display device according to (1), the frame may be formed by bending a metal plate having a uniform thickness.

(3) In the liquid crystal display device according to (2), the frame may extend, from the first portion that supports the light guide plate, in a direction away from the light guide plate in a direction facing the light guide plate, bend to extend in a direction in which the edge surface of the light guide plate faces, and bend to reach the second portion.

(4) In the liquid crystal display device according to any one of (1) to (3), the metal block may be in contact with the second portion of the frame.

(5) In the liquid crystal display device according to any one of (1) to (4), the metal block may be in contact with the housing.

(6) In the liquid crystal display device according to any one of (1) to (4), the frame may support a rear surface of the liquid crystal display panel, the liquid crystal display device may further have an outer frame that supports a front surface of the liquid crystal display panel, and a portion of the outer frame may be interposed between the metal block and the housing.

### BRIEF DESCRIPTION OF THE DRAWINGS

FIG. 1 is an elevation view of a liquid crystal display device according to an embodiment of the invention.

FIG. 2 is a cross-sectional view of the liquid crystal display device shown in FIG. 1 taken along line II-II.

FIG. 3 is a plan view showing a wiring board on which a plurality of light emitting components are mounted.

FIG. 4 shows a modified example of the embodiment.

### DETAILED DESCRIPTION OF THE INVENTION

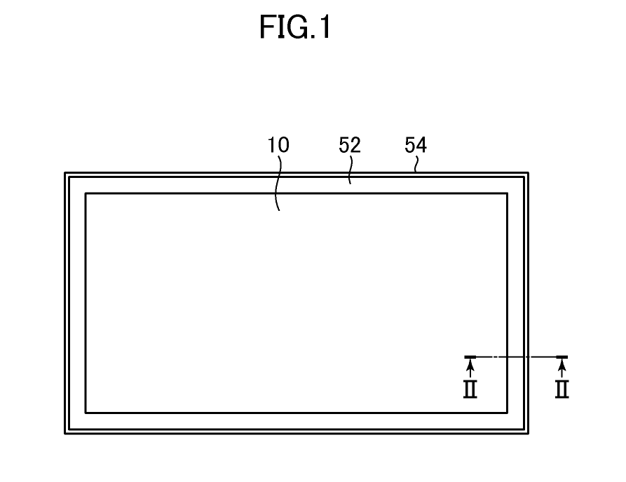

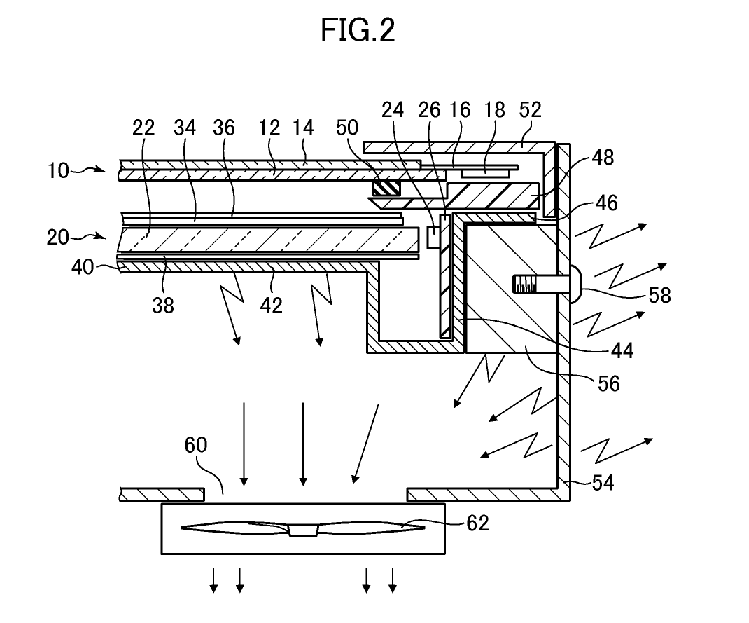

Hereinafter, an embodiment of the invention will be described with reference to the drawings. FIG. 1 is an elevation view of a liquid crystal display device according to the embodiment of the invention. FIG. 2 is a cross-sectional view of the liquid crystal display device shown in FIG. 1 taken along line II-II.

The liquid crystal display device has a liquid crystal display panel 10. The liquid crystal display panel 10 includes a pair of substrates 12 and 14 made of glass or the like and a liquid crystal material (not shown) interposed therebetween. The liquid crystal display panel 10 has polarizers (not shown) respectively disposed outside the pair of substrates 12 and 14. The substrate 12 protrudes from the substrate 14. At the portion of the substrate 12 protruding from the substrate 14, a flexible wiring board 16 is attached on a surface on the side facing the substrate 14. An integrated circuit chip 18 incorporating a driver circuit for driving the liquid crystal material is mounted on the flexible wiring board 16.

The liquid crystal display device has a sidelight type backlight 20 used as a surface light source of the liquid crystal display panel 10. The backlight 20 includes a light guide plate 22 arranged so as to overlap with the liquid crystal display panel 10. The light guide plate 22 converts light of a point light source into a surface light source for illuminating the liquid crystal display panel 10.

The backlight 20 includes surface-mount type light emitting components 24 each of which emits light in an upper surface direction. The light emitting component 24 is a point light source such as a light emitting diode (LED). The point light source has a narrow light emitting region compared to a surface light source. The light emitting component 24 emits white light. The light emitting component 24 is mounted on a wiring board 26 such as a flexible printed circuit (FPC). Light is emitted from the light emitting component 24 in a direction toward which a surface of the wiring board 26 faces, where the light emitting component 24 is mounted on the surface. The light is incident on an edge surface of the light guide plate 22 from the light emitting component 24. An edge of the light guide plate 22 is arranged next to the light emitting component 24 so that the light from the light emitting component 24 is incident on the edge.

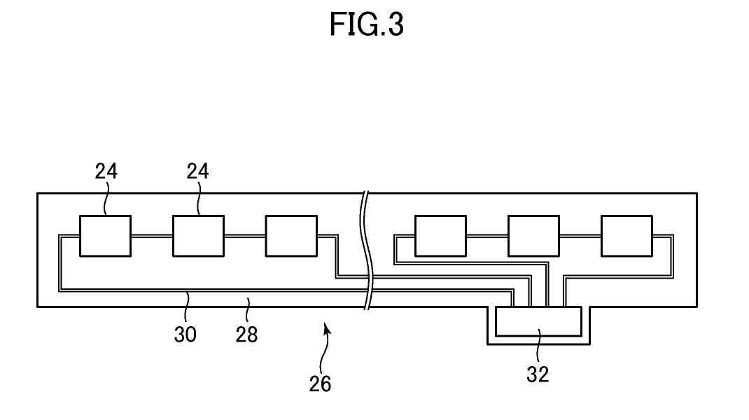

FIG. 3 is a plan view showing the wiring board 26 on which the plurality of light emitting components 24 are mounted. The wiring board 26 includes a base substrate 28 made of a resin or a material including a resin and a wiring pattern 30 formed on the base substrate 28. The light emitting components 24 are electrically connected with the wiring pattern 30. Since a region for forming the wiring pattern 30 is needed, the wiring board 26 is wider than the width of the light emitting component 24. An integrated circuit chip 32 for controlling the turning on and off of the light emitting component 24 is mounted on the wiring board 26.

The backlight 20 includes a light diffusion sheet 34 overlaid on a surface of the light guide plate 22. The light diffusion sheet 34 is arranged on the light guide plate 22 (on the side close to the liquid crystal display panel 10). The light diffusion sheet 34 is arranged from an effective region to a light incident region of the light guide plate 22. The light diffusion sheet 34 has a weak light diffusion action. Therefore, when light passes through the light diffusion sheet 34, an influence on light distribution can be reduced. A prism sheet 36 is arranged on the light diffusion sheet 34 (on the side close to the liquid crystal display panel 10). When light passes through the prism sheet 36, light can be collected at the front of the display panel to improve the front luminance. The light diffusion sheet 34 and the prism sheet 36 are collectively referred to as optical sheet. Moreover, a reflective sheet 38 is arranged below the light guide plate 22 (on the side opposite to the liquid crystal display panel 10).

The liquid crystal display device has a frame 40 that supports the backlight 20. The frame 40 is made of metal and formed by bending a metal plate having a uniform thickness. The frame 40 includes a first portion 42 that supports the light guide plate 22. The first portion 42 is arranged so as to face a rear surface of the light guide plate 22 (surface opposite to the liquid crystal display panel 10). The frame 40 includes a second portion 44 facing the edge surface of the light guide plate 22 with a gap. The frame 40 extends, from the first portion 42 that supports the light guide plate 22, in a direction (downward in FIG. 2) away from the light guide plate 22 in a direction facing the light guide plate 22, bends to extend in a direction (rightward in FIG. 2) toward which the edge surface of the light guide plate 22 faces, and bends to reach the second portion 44. At the second portion 44, the wiring board 26 is attached such that the light from the light emitting component 24 is incident on the edge surface of the light guide plate 22. For the attachment, an adhesive material (for example, a double-faced tape) (not shown) may be used. The frame 40 includes a third portion 46 for supporting the liquid crystal display panel 10. The first portion 42, the second portion 44, and the third portion 46 are integrally formed.

The display device has an inner frame 48. The inner frame 48 is a resin molded article, which is also called a mold. The inner frame 48 is present between the third portion 46 of the frame 40 and the liquid crystal display panel 10. Further, an elastic body 50 (for example, rubber) is present between the inner frame 48 and the liquid crystal display panel 10. The elastic body 50 is attached on a rear surface of the liquid crystal display panel 10, and absorbs an impact when the liquid crystal display panel 10 comes into contact with the inner frame 48. The frame 40 supports the rear surface of the liquid crystal display panel 10 via the inner frame 48 and the elastic body 50.

A peripheral portion of a front surface (image display surface) of the liquid crystal display panel 10 is supported by an outer frame 52. That is, the peripheral portion of the liquid crystal display panel 10 is interposed between the inner frame 48 and the outer frame 52.

The liquid crystal display device has a housing 54. A metal block 56 is present between the frame 40 and the housing 54. Since the metal block 56 is present therebetween, the frame 40 can be prevented from deforming even when the housing 54 is distorted. Due to this, since the deformation of the wiring board 26 can be suppressed, a stress is not generated at the light emitting component 24 or a joining portion of the light emitting component 24 and the wiring pattern 30 of the wiring board 26.

The housing 54 and the metal block 56 are fixed to each other with a screw 58. The metal block 56 is in contact with the housing 54. Reinforcement of the housing 54 is to be achieved by the metal block 56. The metal block 56 is fixed to the housing 54 and a surface of the second portion 44 of the frame 40, the surface being on the side opposite to the surface on which the wiring board 26 is attached. The metal block 56 is in contact with the second portion 44 of the frame 40 but not in contact with the outer frame 52.

The housing 54 covers the frame 40 and the metal block 56 on the rear surface side of the liquid crystal display panel 10. A space is formed between the frame 40 and the housing 54. An opening 60 that allows this space to be in communication with the outside is formed in the housing 54. A fan 62 is attached to face the opening 60 of the housing 54, so that heat inside the housing 54 can be forcibly discharged by the fan 62.

According to the embodiment, since the metal block 56 allows the heat conducted from the light emitting component 24 to the wiring board 26 to escape from the frame 40 to the housing 54, the heat dissipation property of the backlight 20 can be enhanced. The fan 62 is an additional member for enhancing the heat dissipation property. Therefore, when a sufficient heat dissipation property can be obtained by the provision of the metal block 56, the fan 62 may be omitted.

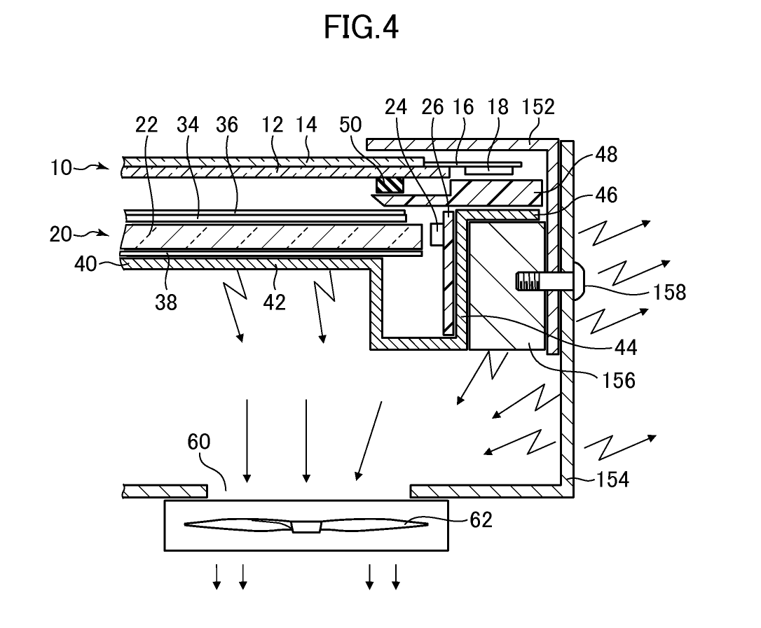

FIG. 4 shows a modified example of the embodiment. In this example, a portion of an outer frame 152 is interposed between a metal block 156 and a housing 154. With the fastening of a screw 158, the outer frame 152 is interposed between the housing 154 and the metal block 156 to be in contact with the housing 154 and the metal block 156. Due to this, the outer frame 152 also contributes to heat dissipation, which is more preferable.

While there have been described what are at present considered to be certain embodiments of the invention, it will be understood that various modifications maybe made thereto, and it is intended that the appended claims cover all such modifications as fall within the true spirit and scope of the invention.

What is claimed is:

1. A liquid crystal display device comprising:
a liquid crystal display panel;
a sidelight type backlight used as a surface light source of the liquid crystal display panel;
a frame that supports the liquid crystal display panel and the backlight;
a housing; and
a metal block present between the frame and the housing; wherein
the backlight includes a surface-mount type light emitting component that emits light in an upper surface direction, a wiring board on which the light emitting component is mounted, and a light guide plate arranged so as to overlap with the liquid crystal display panel,
the frame integrally includes a first portion that supports the light guide plate, a second portion facing an edge surface of the light guide plate with a gap, and a third portion that supports the liquid crystal display panel,
the wiring board is attached to the second portion such that the light from the light emitting component is incident on the edge surface of the light guide plate, and
the metal block is fixed to the housing and a surface of the second portion of the frame, the surface being on the side opposite to a surface on which the wiring board is attached.

2. The liquid crystal display device according to claim 1, wherein
the frame is formed by bending a metal plate having a uniform thickness.

3. The liquid crystal display device according to claim 2, wherein
the frame extends, from the first portion that supports the light guide plate, in a direction away from the light guide plate in a direction facing the light guide plate, bends to extend in a direction in which the edge surface of the light guide plate faces, and bends to reach the second portion.

4. The liquid crystal display device according to claim 1, wherein
the metal block is in contact with the second portion of the frame.

5. The liquid crystal display device according to claim 1, wherein
the metal block is in contact with the housing.

6. The liquid crystal display device according to claim 1, wherein
the frame supports a rear surface of the liquid crystal display panel,
the liquid crystal display device further has an outer frame that supports a front surface of the liquid crystal display panel, and
a portion of the outer frame is interposed between the metal block and the housing.
